(19) United States
(12) Patent Application Publication
(10) Pub. No.: US 2026/0257535 A1
(43) Pub. Date: Sep. 3, 2026

(54) AIR CONDITIONER

(71) Applicant: Sanden Corporation, Isesaki-shi, Gunma (JP)

(72) Inventors: Joji ARAI, Isesaki-shi, Gunma (JP); Satoshi FUJIKAWA, Isesaki-shi, Gunma (JP); Hiroshi HONDA, Isesaki-shi, Gunma (JP); Yasushi MURAKOSHI, Isesaki-shi, Gunma (JP); Shoji TAKEMOTO, Isesaki-shi, Gunma (JP)

(73) Assignee: Sanden Corporation, Isesaki-shi, Gunma (JP)

(21) Appl. No.: 19/164,933

(22) PCT Filed: Jun. 21, 2024
(86) PCT No.: PCT/JP2024/022500

§ 371 Date: Sep. 12, 2025

(30) Foreign Application Priority Data
Jul. 5, 2023 (JP) 2023-1104358

(51) Int. Cl. B60H 1/32; F24F 11/46; F24F 11/86

(52) U.S. Cl. CPC B60H 1/3211; F24F 11/46; F24F 11/86; B60H 2001/3238; B60H 2001/3272

(57) ABSTRACT

An air-conditioning apparatus is provided which is capable of controlling power usage within power limits of a power supply in a relatively small air-conditioning apparatus in which a condenser is placed below an evaporator and effectively using the air-conditioning (cooling) capacity. An air-conditioning apparatus 100 includes a housing 60 configured to accommodate a refrigerant circuit R having: a compressor 10; a condenser 20; an evaporator 30; and an expansion device 40, and a control device 50, in which the control device 50 includes: an upper operation limit value decision unit 502; a rotation speed command value decision unit 503; and a compressor rotation control unit 506, the upper operation limit value decision unit 502 executes control of deciding an upper operation limit value Rrmax of the compressor 10 with reference to a load on the compressor 10, the rotation speed command value decision unit 503 executes control of: deciding a rotation speed command value Rc with reference to a target discharge temperature Ttgt and a present rotation speed Rnow of the compressor 10 in a case where the load is relatively low; and deciding that the present rotation speed Rnow or the upper operation limit value Rrmax is a rotation speed command value Rc in a case where the load is relatively high, and the compressor rotation control unit 506 controls the drive of the compressor 10 on the basis of the rotation speed command value Rc.

### TECHNICAL FIELD

The present invention relates to an air-conditioning apparatus.

### BACKGROUND ART

Relatively small air-conditioning apparatuses (what is called a spot cooler and a portable cooler) are conventionally known in which a refrigerant circuit including a compressor, a condenser, an expansion device, and an evaporator, and a fan are accommodated in a single case, and the condenser is placed below the evaporator. A configuration of such air-conditioning apparatuses is also known in which condensed water (condensate water) produced by the evaporator is caused to flow to the condenser and the condenser is cooled to improve energy consumption efficiency (Coefficient Of Performance: COP) (refer to, for example, Patent Literature 1). Moreover, examples of power supplies for these air-conditioning apparatuses (a spot cooler and a portable cooler) include an AC power supply, a rechargeable battery, and a cigarette lighter/power outlet of a vehicle.

### CITATION LIST

### Patent Literature

Patent Literature 1: JP-A-2022-148686

### SUMMARY OF INVENTION

### Problems to be Solved by Invention

However, in a case of an air-conditioning apparatus that uses a cigarette lighter/power outlet as a power supply, it is difficult to effectively use the air-conditioning (cooling) capacity.

Specifically, for example, the required power of the air-conditioning apparatus varies greatly depending on the outside environment. The required power is high in a high temperature/high humidity environment, that is, in an operation under high-load conditions with respect to the capacity of the air-conditioning apparatus, and the required power is low in an operation in a low temperature/low humidity environment (under low-load conditions with respect to the capacity of the air-conditioning apparatus). In a case of the cigarette lighter/power outlet, the power supply voltage is 12 V or 24 V. Therefore, if an upper limit of the cooling capacity is set in an operating range under low-load conditions, it results in exceeding the power limit of the cigarette lighter/power outlet under high-load conditions. Hence, it is necessary to set the upper limit of the cooling capacity in an operating range under high-load conditions. If that happens, a surplus of the air-conditioning capacity occurs under low-load conditions.

Moreover, in particular, in a case of an air-conditioning apparatus configured to cool a condenser, reusing condensed water for the purpose of improving energy consumption efficiency (the COP) as in the technology described in Patent Literature 1, when the condenser starts being cooled by the produced condensed water after a lapse of time since the start of operation, the efficiency of the cooling cycle increases and the required power decreases sharply. Even in such a case, from the viewpoint of safety, the upper limit of the cooling capacity is conventionally set according to a state before the condensed water is produced, that is, a state where the efficiency of the cooling cycle is low (low efficiency). Hence, there is a problem that the cooling capacity cannot be improved even if time passes since the start of the operation, the cooling cycle enters a high-efficiency state due to the production of the condensed water, and there is a margin for power.

In view of such circumstances, the present invention aims to provide an air-conditioning apparatus capable of controlling power usage within power limits of a power supply in a relatively small air-conditioning apparatus in which a condenser is placed below an evaporator and effectively using the air-conditioning (cooling) capacity.

### Solution to Problems

The present invention is related to an air-conditioning apparatus including a housing configured to accommodate a refrigerant circuit having: a compressor; a condenser; a decompression device; and an evaporator, and a control device, in which the control device includes: an upper operation limit value decision unit; a rotation speed command value decision unit; and a compressor rotation control unit, the upper operation limit value decision unit executes control of deciding an upper operation limit value that is an upper rotation speed limit for driving the compressor, with reference to a load on the compressor, the rotation speed command value decision unit executes control of: deciding a rotation speed command value with reference to a target discharge temperature and a rotation speed of the compressor in a present state (hereinafter referred to as the “present rotation speed”.) in a case where the load is relatively low; and deciding that the present rotation speed or the upper operation limit value is the rotation speed command value in a case where the load is relatively high, and the compressor rotation control unit controls the drive of the compressor on the basis of the rotation speed command value.

### Effects of Invention

According to the present invention, it is possible to exert an excellent effect of being able to provide an air-conditioning apparatus capable of controlling power usage within power limits of a power supply in a relatively small air-conditioning apparatus in which a condenser is placed below an evaporator and effectively using the air-conditioning (cooling) capacity.

### BRIEF DESCRIPTION OF DRAWINGS

FIG. 1 is a diagram illustrating a schematic configuration of an air-conditioning apparatus according to an embodiment of the present invention.

FIG. 2 is a circuit diagram illustrating a schematic configuration of the air-conditioning apparatus according to the embodiment of the present invention.

FIG. 3 is a block diagram illustrating a schematic configuration of a control device of the air-conditioning apparatus according to the embodiment of the present invention.

FIG. 4 is a functional block diagram of the control device of the air-conditioning apparatus according to the embodiment of the present invention.

FIG. 5 is a flowchart illustrating the flow of a compressor drive control process according to the embodiment of the present invention.

FIG. 6 is a flowchart illustrating the flow of processes of an upper operation limit value decision process according to the embodiment of the present invention.

FIG. 7 is a flowchart illustrating the flow of a command value setting process according to the embodiment of the present invention.

FIG. 8 is a flowchart illustrating the flow of an upper limit determination process according to the embodiment of the present invention.

FIG. 9 is a table illustrating setting examples of a rotation speed command value in the embodiment of the present invention.

### DESCRIPTION OF EMBODIMENTS

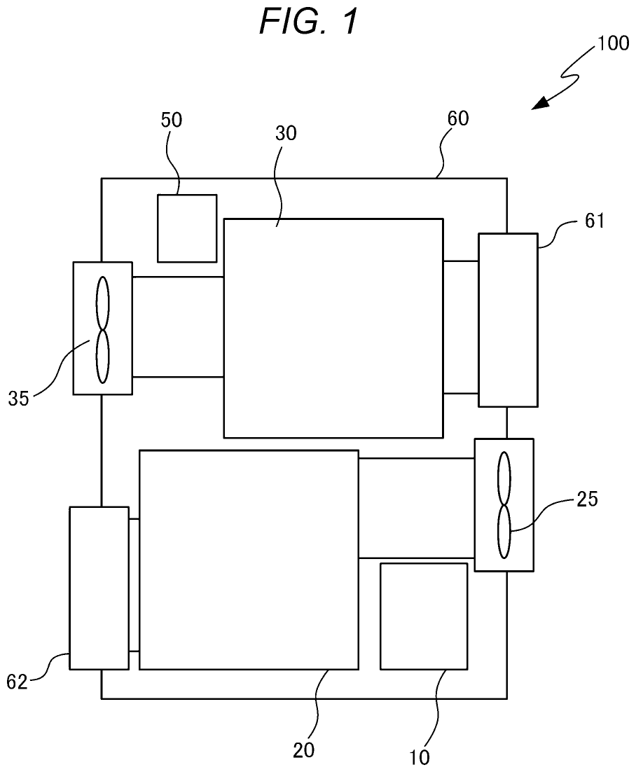

An embodiment of the present invention is described hereinafter with reference to the accompanying drawings. FIGS. 1 to 9 are examples of the embodiment of the present invention, and portions to which the same reference signs are assigned indicate portions having the same functions in the drawings, and redundant descriptions thereof in the drawings are omitted as appropriate.

### Air-Conditioning Apparatus

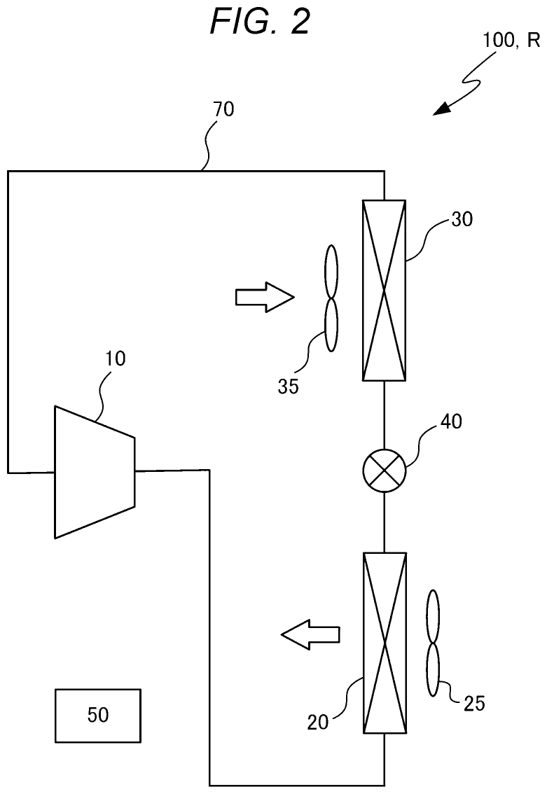

FIG. 1 is a schematic side view schematically illustrating the configuration of an air-conditioning apparatus 100 according to one embodiment of the present invention. FIG. 2 is a schematic circuit diagram explaining a refrigerant circuit R in the air-conditioning apparatus 100 of the embodiment.

With reference to FIG. 1, the air-conditioning apparatus 100 is, for example, what is called a spot cooler (portable cooler) that can carry out, for example, local air conditioning or personal air conditioning in a vehicle's cabin or a relatively small space (hereinafter, the vehicle's cabin, etc.) by use of a cigarette lighter/power outlet of the vehicle as a power supply. The air-conditioning apparatus 100 includes, for example, a condenser 20, a condenser-specific fan 25, a compressor 10, an evaporator 30, an evaporator-specific fan 35, an expansion device (such as a capillary tube) not illustrated in FIG. 1, a control device 50, and a housing 60 that accommodates them. The housing 60 is provided with, for example, a discharge port 61 that delivers air into, for example, the vehicle's cabin, etc., and an exhaust port 62 of the air-conditioning apparatus 100.

The air-conditioning apparatus 100 is configured in such a manner that the condenser 20 is placed below the evaporator 30 in a vertical direction in the discrete housing 60, and condensed water produced by the evaporator 30 is caused to flow down to the condenser 20. Specifically, for example, a receiving pan (not illustrated) that receives the condensed water and a condensed water channel (not illustrated) that draws the condensed water around as needed are provided below the evaporator 30, and the condensed water produced by the evaporator 30 is caused to flow down to, for example, a surface (of a tube) of the condenser 20.

With reference to FIG. 2, the compressor 10, the condenser 20, an expansion device 40, and the evaporator 30 are connected by piping 70 in the air-conditioning apparatus 100. A refrigerant circulates in the piping 70 to form the refrigerant circuit R in which the refrigerant circulates in the order of the compressor 10, the condenser 20, the expansion device 40, and the evaporator 30.

The compressor 10 compresses the refrigerant flowing in the piping 70. The refrigerant that has been compressed into high pressure gas is delivered to the condenser 20 through the piping 70. The refrigerant is liquefied in the condenser 20. The refrigerant that has passed through the condenser 20 is decompressed in the expansion device 40 and delivered to the evaporator 30 through the piping 70.

The evaporator 30 is a heat exchanger being a part of the refrigerant circuit R, and causes the air blown from the evaporator-specific fan 35 through an air intake opening portion (not illustrated) of the housing 60 to exchange heat with the refrigerant in a main body of the evaporator 30. The air (cold air) that has been cooled by the heat exchange is delivered to the vehicle's cabin, etc. through the discharge port 61 provided in the housing 60.

The condenser 20 is a heat exchanger being a part of the refrigerant circuit R, and causes the air blown from the condenser-specific fan 25 through an air intake opening portion (not illustrated) of the housing 60 to exchange heat with the refrigerant in a main body of the condenser 20. The air that has exchanged heat is delivered out through the exhaust port 62.

Note that the configuration of the air-conditioning apparatus 100 is not limited to the example of FIG. 1. For example, it may be configured in such a manner that the condenser 20 and the evaporator 30 share one fan as an air intake means, and a channel for air in the housing 60 branches into a path flowing into the evaporator 30 and a channel flowing into the condenser 20. Moreover, the condenser 20 may be configured in such a manner as to be covered with, for example, a cover provided with a channel for the condensed water.

With reference to FIGS. 1 and 2, the air-conditioning apparatus 100 of the embodiment causes the condensed water produced by the evaporator 30 to flow down to the condenser 20. The condensed water is produced by cooling moisture in the air blown from the evaporator-specific fan 35 by heat absorption of the evaporator 30. The condensed water is reused and caused to flow down to the condenser 20. Therefore, the cold of the condensed water is recovered by the condenser 20, and the dissipation of heat of the refrigerant flowing in the tube of the condenser 20 is encouraged. Consequently, the cooling efficiency in the refrigerant circuit R can be improved. Whole or part of the condensed water is evaporated by the dissipation of heat of the condenser 20.

In the embodiment, as described above, the air-conditioning apparatus 100 capable of improving the cooling efficiency can effectively use the cooling capacity without waste particularly in an operating range where the cooling efficiency improves (with a highly efficient cooling cycle) and/or an operating range where a load on the compressor 10 is low. This is described below.

### Control Device

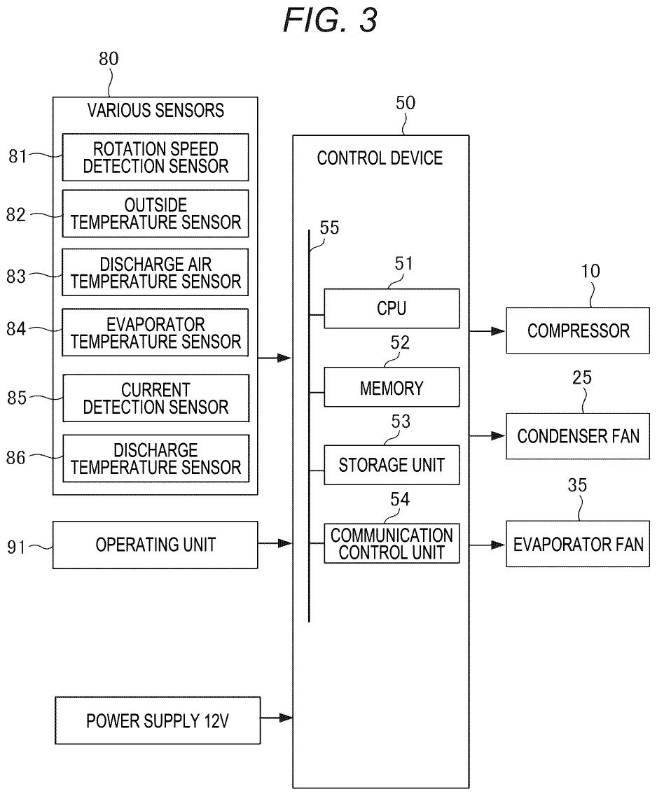

FIG. 3 is a block diagram schematically illustrating a hardware configuration of the control device 50 that is responsible for controlling the air-conditioning apparatus 100, and input/output relationships between the control device 50 and other components of the air-conditioning apparatus 100. Note that FIG. 3 illustrates extracted prime components in terms of description of the embodiment, and known components other than the illustrated components are included as hardware configurations of the air-conditioning apparatus 100 and the control device 50, but illustrations thereof are omitted.

The control device 50 of the embodiment includes a central processing unit (CPU) 51, a memory 52 such as read only memory (ROM) and random access memory (RAM), a nonvolatile storage unit 53 such as a hard disk drive (HDD) and a solid state drive (SSD), and a communication control unit 54. The CPU 51, the memory 52, the storage unit 53, and the communication control unit 54 are connected to one another via an internal bus 55 in such a manner as to be capable of communicating with one another. Various programs including a compressor drive control program described below are stored in the storage unit 53.

For example, various sensors (detectors) 80 and an operating unit 91 are connected to the control device 50, and outputs thereof are inputted into the control device 50. The various sensors 80 include at least a rotation speed detection sensor 81 that detects the rotation speed of the compressor 10, an outside temperature sensor 82 that detects the outside temperature, an evaporator temperature sensor 84 that detects the temperature of the evaporator 30 (the temperature of the air that has passed through the evaporator 30 or the temperature of the evaporator 30 itself), a current detection sensor 85 that detects the current consumed by the compressor 10, and a discharge temperature sensor 86 that detects, at the discharge port 61, the temperature of the air that is discharged into the vehicle's cabin.

The operating unit 91 includes, for example, a touchscreen, and includes operating means such as a power switch, a cooling switch, and a fan speed switch, and display means such as power on/off display, cooling on/off display, fan speed display, and error display.

On the other hand, for example, the compressor 10, the condenser-specific fan 25, and the evaporator-specific fan 35 are connected to outputs of the control device 50. The control device 50 controls each component of the air-conditioning apparatus 100 on the basis of outputs of the various sensors 80 and a value (such as a fan speed) inputted into the operating unit 91.

Note that in FIG. 3, the control device 50 and the various sensors 80 may be integrally constructed using, for example, a one-chip microcomputer.

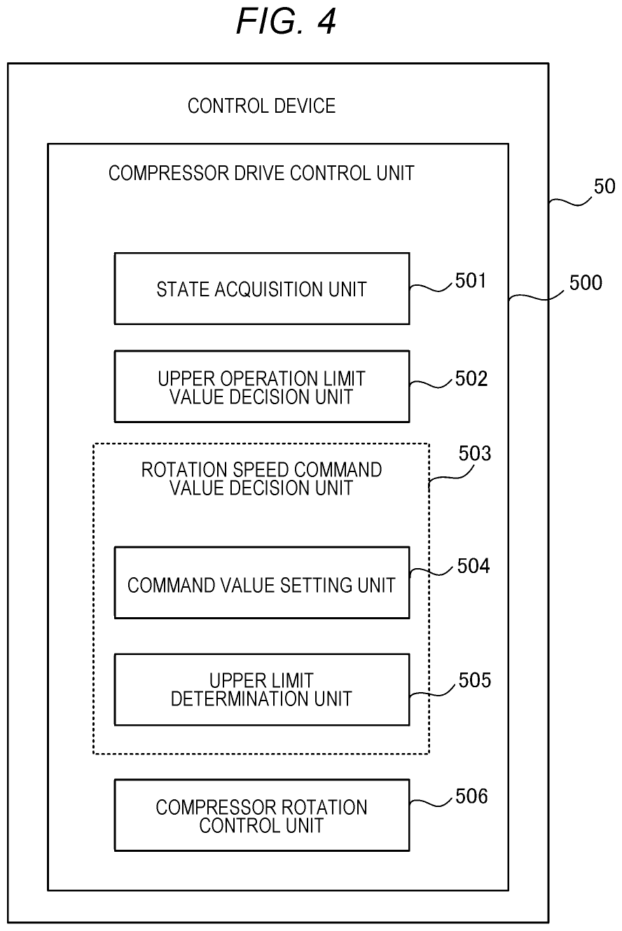

FIG. 4 is a block diagram illustrating a functional configuration of the control device 50. The control device 50 functions as, for example, a compressor drive control unit 500 that executes drive control of the compressor 10.

### Compressor Drive Control Unit

The compressor drive control unit 500 includes, for example, a state acquisition unit 501 that acquires, for example, an outside environment and the states of the air-conditioning apparatus 100 and the compressor 10, an upper operation limit value decision unit 502 that decides an upper operation limit value Rrmax that is an upper rotation speed limit for driving the compressor 10, a rotation speed command value decision unit 503 that decides a command value (a rotation speed command value Rc) used to control the rotation of the compressor 10, and a compressor rotation control unit 506 that controls the drive of the compressor 10 on the basis of the rotation speed command value Rc. The compressor drive control unit 500 updates the upper operation limit value Rrmax and the rotation speed command value Rc at predetermined intervals (for example, intervals of 10 seconds).

### State Acquisition Unit

The state acquisition unit 501 acquires, as the state of the compressor 10, output results of, for example, the rotation speed detection sensor 81, the outside temperature sensor 82, the evaporator temperature sensor 84, the current detection sensor 85, and the discharge temperature sensor 86. The state acquisition unit 501 acquires these output results periodically (for example, every second) by interrupt handling, and stores the output results in the storage unit 53.

### Upper Operation Limit Value Decision Unit

The upper operation limit value decision unit 502 determines the load on the compressor 10 with reference to the state of the compressor 10 acquired by the state acquisition unit 501. Here, the “load on the compressor 10” is, for example, a required value for the compressor 10 to maintain a temperature (a target discharge temperature Ttgt) at which air is discharged into a space in which the air-conditioning apparatus 100 is placed, such as the vehicle's cabin, etc.

The upper operation limit value decision unit 502 judges that the load on the compressor 10 is relatively low, for example, at least either if the outside environment is at a low temperature and/or a low humidity or if the cooling cycle in the refrigerant circuit R is in a high-efficiency state. Hereinafter, a state in which the load on the compressor 10 is relatively low is referred to as the “low-load condition.”

Moreover, the upper operation limit value decision unit 502 judges that the load on the compressor 10 is relatively high, for example, at least either if the outside environment is at a high temperature and/or a high humidity or if the cooling cycle in the refrigerant circuit R is in a low-efficiency state. Hereinafter, a state in which the load on the compressor 10 is relatively high is referred to as the “high-load condition.” The load on the compressor 10 can be calculated on the basis of at least any of the outside environment (such as the outside temperature and the outside humidity), the state of the air-conditioning apparatus 100 (such as a fan speed setting, and production state of the condensed water), and the state of the compressor 10 (such as the current consumed).

In the embodiment, as an example, the high-load condition and the low-load condition are determined on the basis of the current consumed by the compressor 10. Specifically, it is calculated and determined how much current is consumed by the compressor 10 in the present state (at the current time) with respect to an upper current limit value Irmt of the power supply (cigarette lighter/power outlet). As the upper current limit value Irmt of the power supply (cigarette lighter/power outlet), for example, a fixed value (10 A in this example) in relation to a power supply voltage (12 V or 24 V) is held in the storage unit 53 of the control device 50.

The low-load condition is a state in which there is a margin for the capacity of the compressor 10 and the rotation of the compressor 10 can be controlled with reference to, for example, a discharge temperature (giving priority to comfort). On the other hand, the high-load condition is a state in which a certain restriction is imposed on control over the rotation of the compressor 10 (priority to comfort is lowered). Specifically, the high-load condition includes a “first high-load condition” in which the current consumed in the present state is nearly the upper current limit value Irmt, and control is required to maintain the rotation speed of the compressor 10 in order to prevent the rotation speed from increasing to or above the rotation speed in the present state (at the current time) (hereinafter referred to as the “present rotation speed Rnow”), and a “second high-load condition” in which there is almost no difference (margin) from the upper current limit value Irmt, and control is required to reduce the present rotation speed in order to reduce the current consumed quickly. The second high-load condition can also be said to be an urgent or emergency condition.

The upper operation limit value decision unit 502 calculates the ratio of the present (latest) current consumed that has been acquired by the state acquisition unit 501 to the upper current limit value Irmt (the proportion of the current consumed to the upper current limit value Irmt; hereinafter referred to as the “Irmt ratio”). Thresholds (a first threshold and a second threshold) are then set for the Irmt ratio and, therefore, the state of the compressor 10 is judged. Specifically, the compressor 10 is judged to be in the low-load condition if the Irmt ratio is less than the first threshold. The compressor 10 is judged to be in the first high-load condition (the high-load condition) if the Irmt ratio is equal to or greater than the first threshold and less than the second threshold. The compressor 10 is judged to be in the second high-load condition (the high-load condition) if the Irmt ratio is equal to or greater than the second threshold (up to the upper current limit value Irmt). The first threshold is, for example, 90%, and the second threshold is, for example, 95%.

The upper operation limit value decision unit 502 decides the upper operation limit value Rrmax of the compressor 10 with reference to the determined load (the state of the compressor 10). Specifically, in a case of the low-load condition, the upper operation limit value decision unit 502 decides that a maximum rotation speed of the compressor 10 is the upper operation limit value Rrmax. The maximum rotation speed is a fixed value preset (held in the storage unit 53 of the control device 50) according to the power supply voltage 12 V or 24 V, and is, for example, 3480 rpm. Moreover, in a case of the first high-load condition, the upper operation limit value decision unit 502 decides that the present rotation speed Rnow is the upper operation limit value Rrmax.

Moreover, in a case of the second high-load condition, the upper operation limit value decision unit 502 sets a rotation speed obtained by correcting the present rotation speed Rnow with a first correction value (adding the first correction value to the present rotation speed Rnow) as the upper operation limit value Rrmax. In the second high-load condition, it is necessary to reduce the rotation speed quickly, and therefore, the first correction value is, for example, −120 rpm. In other words, in the case of the second high-load condition, the upper operation limit value decision unit 502 decides that a value obtained by subtracting 120 rpm from the present rotation speed Rnow is the upper operation limit value Rrmax. However, if, in the case of the second high-load condition, the present rotation speed Rnow falls below a minimum rotation speed of the compressor 10 as a result of being corrected with the first correction value, the upper operation limit value decision unit 502 (the compressor drive control unit 500) stops the compressor 10. The minimum rotation speed is a fixed value preset (held in the storage unit 53 of the control device 50) according to the power supply voltage 12 V or 24 V, and is, for example, 2100 rpm.

### Rotation Speed Command Value Decision Unit

The rotation speed command value decision unit 503 can execute control of deciding the rotation speed command value Rc with reference to the target discharge temperature Ttgt and an actual discharge temperature Tr detected by the discharge temperature sensor 86, and the present rotation speed Rnow of the compressor 10 if the state of the compressor 10 is the low-load condition, and control of deciding that the present rotation speed Rnow or the upper operation limit value Rrmax is the rotation speed command value Rc in a case of the high-load condition.

Specifically, the rotation speed command value decision unit 503 includes a command value setting unit 504 and an upper limit determination unit 505. In the case of the low-load condition, the command value setting unit 504 corrects the present rotation speed Rnow with a predetermined correction value with reference to a difference between the target discharge temperature Ttgt and the actual discharge temperature Tr, and sets a value obtained by increasing or decreasing, or maintaining the present rotation speed Rnow as the rotation speed command value Rc. As the correction value in this case, for example, any of a second correction value (+120 rpm), a third correction value (+60 rpm), a fourth correction value (±0), and a fifth correction value (−60 rpm) is selected.

A target discharge temperature difference ΔTt is calculated by the following (equation 1) or (equation 2) on the basis of the outside temperature detected by the outside temperature sensor 82, and then the target discharge temperature Ttgt is calculated by (equation 3).

In case of outside temperature of 35° C. or lower

Target discharge temperature difference ΔTt=outside temperature −20[° C.] (equation 1)

In case of outside temperature over 35° C.

Target discharge temperature difference ΔTt=15[° C.] (equation 2)

Target discharge temperature Ttgt=outside temperature-target discharge temperature difference ΔTt [° C.] (equation 3)

Moreover, in the case of the first high-load condition, the command value setting unit 504 sets, as the rotation speed command value Rc, either a value obtained by correcting the present rotation speed Rnow with a correction value (for example, the same value as the fifth correction value) with reference to the actual discharge temperature Tr and the target discharge temperature Ttgt and reducing the present rotation speed Rnow, or the present rotation speed Rnow. Specifically, if it is judged that the actual discharge temperature Tr is lower than the target discharge temperature Ttgt and a temperature difference between the two is equal to or greater than a predetermined value (for example, 1° C.) (hereinafter may be referred to as the “first high-load condition (at a low temperature).”), it can be said to be a state in which there is a slight margin for the capacity of the compressor 10 even in the high-load condition. In this case, a value corrected by adding the fifth correction value (for example, −60 rpm) to the present rotation speed Rnow (a value obtained by reducing the present rotation speed Rnow) is set as the rotation speed command value Rc.

On the other hand, if it is judged that the difference between the actual discharge temperature Tr and the target discharge temperature Ttgt is small, or that the actual discharge temperature Tr is higher than the target discharge temperature Ttgt (hereinafter may be referred to as the “first high-load condition (at a non-low temperature).”), it is a state in which there is little margin for the capacity of the compressor 10, and therefore, the present rotation speed Rnow is set as the rotation speed command value Rc to maintain the present state.

Moreover, the command value setting unit 504 decides that the upper operation limit value Rrmax is the rotation speed command value Rc.

Moreover, in the cases of the low-load condition and the first high-load condition, the command value setting unit 504 sets the rotation speed command value Rc with the minimum rotation speed of the compressor 10 as a lower limit (by replacing the rotation speed command value Rc with the minimum rotation speed as needed). In the case of the second high-load condition, as described above, the upper operation limit value decision unit 502 makes a comparison with the minimum rotation speed.

The upper limit determination unit 505 compares the rotation speed command value Rc set by the command value setting unit 504 with the upper operation limit value Rrmax, and finally decides the rotation speed command value Rc with the upper operation limit value Rrmax as an upper limit (by replacing the rotation speed command value Rc with the minimum rotation speed as needed).

### Compressor Rotation Control Unit

The compressor rotation control unit 506 controls the drive of the compressor 10 on the basis of the rotation speed command value Rc decided by the rotation speed command value decision unit 503. In other words, in this example, the compressor 10 is driven with the rotation speed command value Rc that is updated every 10 seconds.

### Compressor Drive Control Process

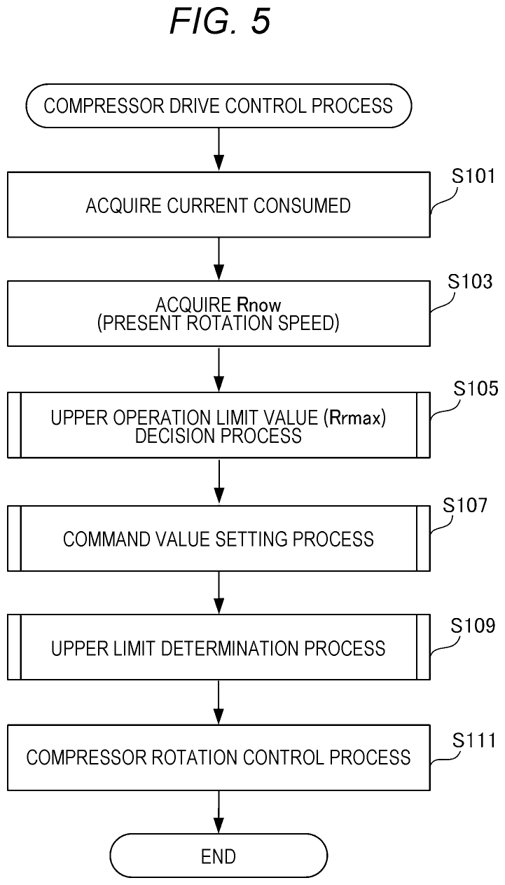

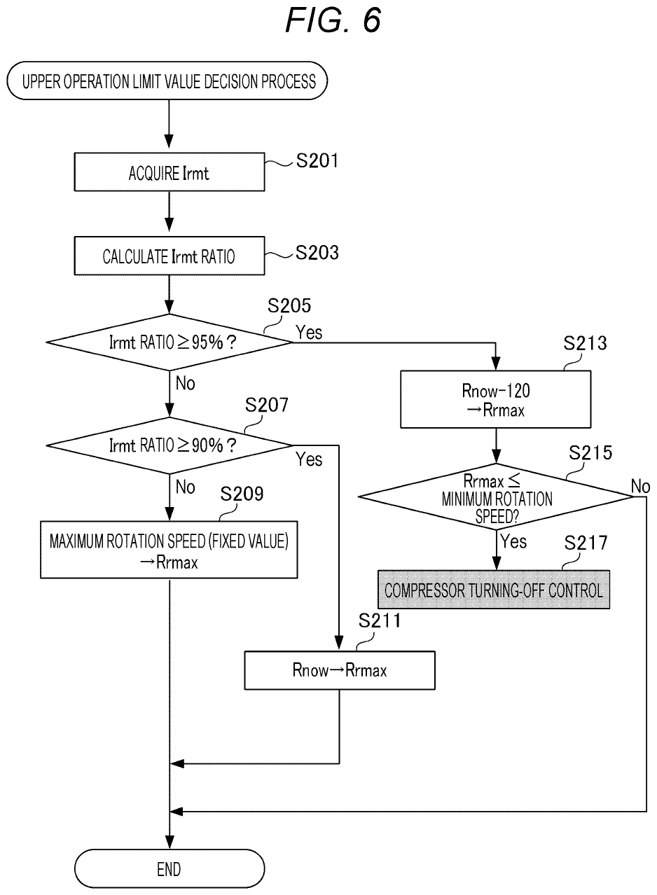

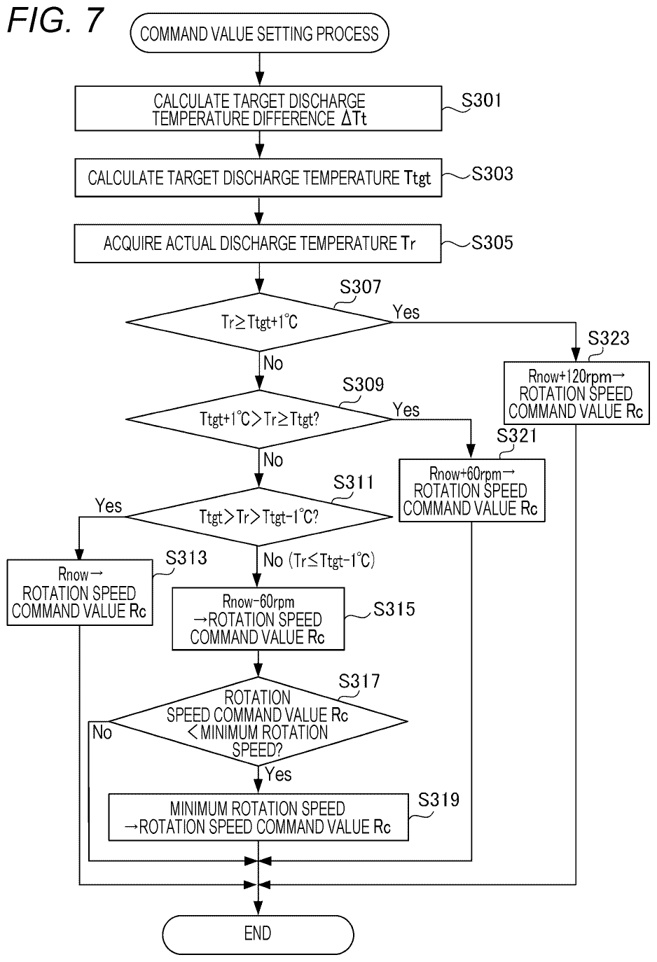

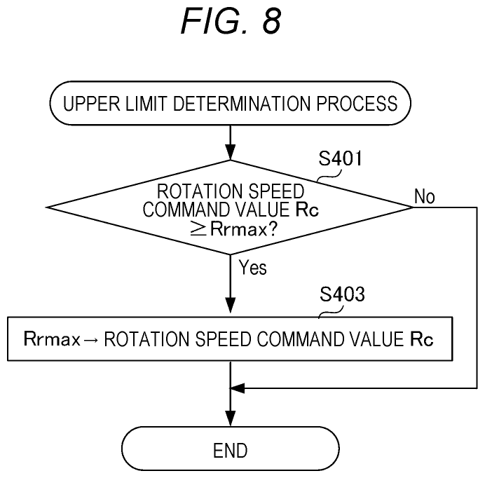

An example of the flow of a compressor drive control process that is executed by the compressor drive control unit 500 is described with reference to FIGS. 5 to 8. FIG. 5 is a flowchart illustrating the flow of the compressor drive control process. FIG. 6 is a flowchart illustrating the flow of an upper operation limit value decision process that is executed by the upper operation limit value decision unit 502. FIG. 7 is a flowchart illustrating the flow of a command value setting process that is executed by the command value setting unit 504. FIG. 8 is a flowchart illustrating the flow of an upper limit determination process that is executed by the upper limit determination unit 505.

The compressor drive control program is read from the storage unit 53, developed into the memory 52, and executed by the CPU 51. As a result, the control device 50 (the compressor drive control unit 500) executes compressor drive control. The control device 50 controls the drive of the compressor 10 on the basis of, for example, the outputs of the various sensors 80 to operate the air-conditioning apparatus 100.

With reference to FIG. 5, the compressor drive control process is executed, for example, at predetermined intervals (for example, 10 seconds) if the compressor 10 starts operating. The state acquisition unit 501 acquires the state of the compressor 10 from the output results of, for example, the rotation speed detection sensor 81, the outside temperature sensor 82, the evaporator temperature sensor 84, the current detection sensor 85, and the discharge temperature sensor 86 periodically (for example, every second) by interrupt handling, and stores these values in the storage unit 53.

Firstly, in step S101, the compressor drive control unit 500 acquires the current consumed in the present state. The current consumed is periodically acquired by the state acquisition unit 501 as the output of the current detection sensor 85, and stored in the storage unit 53. In subsequent step S103, the compressor drive control unit 500 acquires the present rotation speed Rnow. The present rotation speed Rnow is also periodically acquired by the state acquisition unit 501 as the output of the rotation speed detection sensor 81, and stored in the storage unit 53.

In step S105, the upper operation limit value decision process of deciding the upper operation limit value Rrmax with reference to the Irmt ratio (the state of the compressor 10) is performed, and in step S107, the command value setting process of (temporarily) setting the rotation speed command value Rc with reference to the target discharge temperature Ttgt and the actual discharge temperature Tr is performed. In step S109, the upper limit determination process is performed. In the upper limit determination process, the rotation speed command value Rc set in step S107 is compared with the upper operation limit value Rrmax, and the rotation speed command value Rc is finally decided.

In subsequent step S111, the compressor rotation control unit 506 controls the drive of the compressor 10 on the basis of the rotation speed command value Rc decided by the rotation speed command value decision unit 503, and ends the process.

### Upper Operation Limit Value Decision Process

FIG. 6 is a flowchart illustrating an example of the flow of the upper operation limit value decision process in step S105 of FIG. 5. The upper operation limit value decision process is executed by, for example, the upper operation limit value decision unit 502.

In step S201 of the upper operation limit value decision process, the upper operation limit value decision unit 502 acquires the upper current limit value Irmt of the power supply (cigarette lighter/power outlet) and, in step S203, calculates how much current is consumed by the compressor 10 in the present state with respect to the upper current limit value Irmt (the ratio of the current consumed in the present state to the upper current limit value Irmt (the proportion of the current consumed to the upper current limit value Irmt; the Irmt ratio)). In this example, the current consumed in the present state is acquired in step S101 of the compressor drive control process (FIG. 5).

In step S205, it is determined whether or not the Irmt ratio is equal to or greater than the second threshold (95% in this example). If the Irmt ratio is less than the second threshold, the process proceeds to step S207. If the Irmt ratio is equal to or greater than the second threshold, the process proceeds to step S213.

In step S207, it is determined whether or not the Irmt ratio is equal to or greater than the first threshold (90% in this example). If the Irmt ratio is less than the first threshold, the process proceeds to step S209. If the Irmt ratio is equal to or greater than the first threshold, the process proceeds to step S211.

Step S209 is a step to which the process proceeds if the state of the compressor 10 is the low-load condition. In this case, it is decided that a preset maximum rotation speed (a fixed value of 3480 rpm in this example) is the upper operation limit value Rrmax.

Step S211 is a step to which the process proceeds if the state of the compressor 10 is the first high-load condition. In this case, it is decided that the present rotation speed Rnow acquired in step S103 of the compressor drive control process (FIG. 5) is the upper operation limit value Rrmax.

In step S213 to which the process proceeds if the Irmt ratio is equal to or greater than the second threshold (that is, in the second high-load condition) in step S205, a value obtained by correcting the present rotation speed Rnow with the first correction value (−120 rpm) (adding the first correction value to the present rotation speed Rnow) is set as the upper operation limit value Rrmax. In other words, a value obtained by subtracting 120 rpm from the present rotation speed Rnow is the upper operation limit value Rrmax.

In step S215, it is determined whether or not the upper operation limit value Rrmax set in step S213 is equal to or less than the minimum rotation speed. If the upper operation limit value Rrmax is equal to or less than the minimum rotation speed, the process proceeds to step S217. If the upper operation limit value Rrmax exceeds the minimum rotation speed, the process ends. In step S217, a compressor turning-off control process is performed. The compressor turning-off process is a process different from the compressor drive control process, and although the details are omitted, the compressor 10 is stopped, and then restarted after a lapse of a predetermined time under, for example, timer control.

FIG. 7 is a flowchart illustrating an example of the flow of the command value setting process in step S107 of the compressor drive control process (FIG. 5). The command value setting process is executed by, for example, the command value setting unit 504.

In step S301 of the command value setting process, the command value setting unit 504 acquires the outside temperature, and calculates the target discharge temperature difference ΔTt. The outside temperature is acquired by the state acquisition unit 501 as the output of the outside temperature sensor 82, and stored in the storage unit 53. The target discharge temperature difference ΔTt is calculated by (equation 1) or (equation 2) described above with reference to the outside temperature. In step S303, the command value setting unit 504 calculates the target discharge temperature Ttgt by (equation 3) described above.

In step S305, the actual discharge temperature Tr (the temperature of the air at the discharge port 61) is acquired. The actual discharge temperature Tr is acquired by the state acquisition unit 501 as the output of the discharge temperature sensor 86, and stored in the storage unit 53.

In step S307, it is determined whether or not the actual discharge temperature Tr is equal to or higher than the “target discharge temperature Ttgt+1° C..” If the actual discharge temperature Tr is lower than the “target discharge temperature Ttgt+1° C.,” the process proceeds to step S309. If the actual discharge temperature Tr is equal to or higher than the “target discharge temperature Ttgt+1° C.,” the process proceeds to step S323.

In step S309, it is determined whether or not the actual discharge temperature Tr is lower than the “target discharge temperature Ttgt+1° C.” and equal to or higher than the target discharge temperature Ttgt. If so, the process proceeds to step S321. Otherwise (if the actual discharge temperature Tr is lower than the target discharge temperature Ttgt), the process proceeds to step S311. In step S311, it is determined whether or not the actual discharge temperature Tr is lower than the target discharge temperature Ttgt and higher than the target discharge temperature Ttgt−1° C..” If so, the process proceeds to step S313. Otherwise (if the actual discharge temperature Tr is equal to or lower than the “target discharge temperature Ttgt−1° C.”), the process proceeds to step S315.

In step S313 to which the process proceeds if the determination in step S311 is “Yes” (if the actual discharge temperature Tr is lower than the target discharge temperature Ttgt but the difference between the two is relatively small), the value of the present rotation speed Rnow is set as the rotation speed command value Rc (a correction is made by use of the fourth correction value (±0)), and the process ends.

In step S315 to which the process proceeds if the determination in step S311 is “No” (if the actual discharge temperature Tr is lower than the target discharge temperature Ttgt and the difference between the two is large to some extent), a value obtained by correcting the present rotation speed Rnow with the fifth correction value (−60 rpm) (adding the fifth correction value to the present rotation speed Rnow) is set as the rotation speed command value Rc. In other words, a value obtained by subtracting 60 rpm from the present rotation speed Rnow is set as the rotation speed command value Rc.

In step S317, it is determined whether or not the rotation speed command value Rc set in step S315 is lower than the minimum rotation speed. If the rotation speed command value Rc is lower than the minimum rotation speed, the process proceeds to step S319, and if the rotation speed command value Rc is not lower than the minimum rotation speed, the process ends.

In step S319, the rotation speed command value Rc is set again to the minimum rotation speed (replaced with the minimum rotation speed), and the process ends.

In step S321 to which the process proceeds if the determination in step S309 is “Yes” (if the actual discharge temperature Tr is equal to or higher than the target discharge temperature Ttgt and the difference between the two is relatively small), a value obtained by correcting the present rotation speed Rnow with the third correction value (+60 rpm) (adding the third correction value to the present rotation speed Rnow) is set as the rotation speed command value Rc. In other words, a value obtained by adding 60 rpm to the present rotation speed Rnow is set as the rotation speed command value Rc.

In step S323 to which the process proceeds if the determination in step S307 is “Yes” (if the actual discharge temperature Tr is higher than the target discharge temperature Ttgt and the difference between the two is relatively large), a value obtained by correcting the present rotation speed Rnow with the second correction value (+120 rpm) (adding the second correction value to the present rotation speed Rnow) is set as the rotation speed command value Rc. In other words, a value obtained by adding 120 rpm to the present rotation speed Rnow is set as the rotation speed command value Rc.

FIG. 8 is a flowchart illustrating an example of the flow of the upper limit determination process in step S109 of the compressor drive control process (FIG. 5). The upper limit determination process is executed by, for example, the upper limit determination unit 505.

In step S401, the rotation speed command value Rc set by the command value setting process (FIG. 7) is compared with the upper operation limit value Rrmax. If the rotation speed command value Rc is equal to or greater than the upper operation limit value Rrmax, the process proceeds to step S403, and the rotation speed command value Rc is set again to the upper operation limit value Rrmax (replaced with the upper operation limit value Rrmax). If the rotation speed command value Rc is lower than the upper operation limit value Rrmax, the rotation speed command value Rc is maintained, and the process is ended.

Note that in the examples of the flows of the embodiment, the command value setting process illustrated in FIG. 7 causes the rotation speed command value Rc to temporarily change according to the actual discharge temperature Tr and the target discharge temperature Ttgt even in the case of the second high-load condition. However, the upper limit determination unit 505 finally decides that the upper operation limit value Rrmax is the rotation speed command value Rc regardless of the difference between the actual discharge temperature Tr and the target discharge temperature Ttgt.

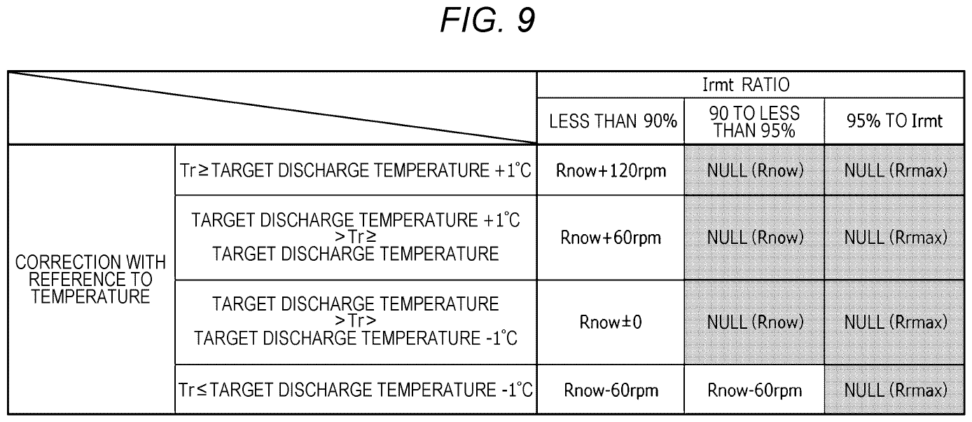

FIG. 9 is a table listing examples of the rotation speed command value Rc that is decided as a result of the compressor drive control process of the embodiment.

In the embodiment, only in the cases of the low-load condition (the Irmt ratio<90%) and the first high-load condition (at a low temperature), that is, at a low temperature (actual discharge temperature Tr≤target discharge temperature Ttgt−1° C.) in the first high-load condition (90%≤Irmt ratio<95%), the present rotation speed Rnow is corrected with a correction value with reference to the temperature to set the rotation speed command value Rc. In other words, the rotation speed command value Rc that gives priority to comfort is set. Specifically, in the case of the low-load condition (Irmt ratio<90%), the rotation speed command value Rc is set with reference to the difference between the actual discharge temperature Tr and the target discharge temperature Ttgt in steps S313, S315, S321, and 323 of the command value setting process (FIG. 7). Moreover, in the case of the first high-load condition (at a low temperature), the rotation speed command value Rc is set (with reference to the difference between the actual discharge temperature Tr and the target discharge temperature Ttgt) in step S315. The low-load condition is a state in which there is a margin for the capacity of the compressor 10, and the first high-load condition (at a low temperature) is a state in which the actual discharge temperature Tr is relatively low although in the high-load condition (a state in which the actual discharge temperature Tr is lower than the target discharge temperature Ttgt and the difference between the two is large), and there is room for a reduction in the rotation speed. In these cases, the present rotation speed Rnow is corrected with reference to the difference between the actual discharge temperature Tr and the target discharge temperature Ttgt to be set as the rotation speed command value Rc.

On the other hand, in the case of the first high-load condition (at a non-low temperature) filled in with gray in FIG. 9, that is, in the case of the first high-load condition and also the actual discharge temperature Tr being higher than the “target discharge temperature Ttgt−1° C.,” and in the case of the second high-load condition, as a result, the correction with reference to the temperature becomes “null”, and the upper operation limit value Rrmax or the present rotation speed Rnow (the same value as the upper operation limit value Rrmax in the first high-load condition (at a non-low temperature)) becomes the rotation speed command value Rc. Specifically, in the first high-load condition (at a non-low temperature) and in the second high-load condition, the rotation speed command value Rc is set in step S321 or step S323 of the command value setting process (FIG. 7), but the rotation speed command value Rc is replaced with the upper operation limit value Rrmax by the upper limit determination process (FIG. 8). In other words, as a result, the present rotation speed Rrnow is not corrected (controlled) with reference to the temperature, and the rotation speed command value Rc is decided on the basis of the current consumed (the Irmt ratio).

As a result, in the high-load condition (the first high-load condition or the second high-load condition), the compressor 10 can be operated at the maximum rotation speed within a range that does not exceed the power that can be used by the power supply (cigarette lighter/power outlet), and sufficient cooling capacity can be exerted. On the other hand, in the low-load condition (a normal condition), the compressor 10 can be operated at a rotation speed at which an optimum discharge temperature is achieved (the difference between the target discharge temperature Ttgt and the actual discharge temperature Tr decreases).

As described above, in the embodiment, different types of control are performed between the low-load condition (and an operating range with a margin for the capacity of the compressor 10 even in the high-load condition) and the high-load condition (an operating range with no margin for the capacity of compressor 10, the operating range filled in with gray). In other words, as a result, as illustrated in FIG. 9, the embodiment is not limited to the process flows illustrated in FIGS. 5 to 8 as long as different types of control are performed between in the state where there is a margin for the capacity of the compressor 10 (for example, in the low-load condition and at a low temperature in the high-load condition) and the state where there is no margin for the capacity of the compressor.

Moreover, in the above embodiment, the normal condition and the high-load condition of the compressor 10 are determined with the thresholds (of the Irmt ratio) based on the current consumed. However, the embodiment is not limited thereto and, for example, it may be configured in such a manner that the outside temperature and/or the outside humidity are detected, and a low load and high efficiency are determined, making a judgement from a combination of the outside temperature and/or the outside humidity and the current consumed. For example, it may be determined to be the normal condition if the temperature is equal to or lower than a threshold and (or) the humidity is equal to or less than a threshold and the Irmt ratio is equal to or less than a threshold.

Moreover, the air-conditioning apparatus 100 may not be configured in such a manner that the condensed water produced by the evaporator 30 is caused to flow down to the condenser 20 and the cold of the condensed water is recovered by the condenser 20 (the condensed water is reusable).

Moreover, the above-mentioned values of the first to fifth correction values are examples, and the first to fifth correction values are not limited to the above-mentioned values. Moreover, in the above embodiment, the correction value in the first high-load condition (at a low temperature) is set to the same value as the fifth correction value, but may be a different value. Moreover, the above-mentioned values of the first and second thresholds are also examples, and may be other values.

Note that the air-conditioning apparatus 100 of the present invention is not limited to the above embodiment and, as a matter of course, various modifications can be added thereto without deviating from the purport of the present invention.

### LIST OF REFERENCE SIGNS

10 Compressor
20 Condenser
25 Condenser-specific fan
30 Evaporator
35 Evaporator-specific fan
40 Expansion device
50 Control device
51 CPU
52 Memory
53 Storage unit
54 Communication control unit
55 Internal bus
60 Housing
61 Discharge port
62 Exhaust port
70 Piping
80 Various sensors (detectors)
81 Rotation speed detection sensor
82 Outside temperature sensor
84 Evaporator temperature sensor
85 Current detection sensor
86 Discharge temperature sensor
91 Operating unit
100 Air-conditioning apparatus
500 Compressor drive control unit
501 State acquisition unit
502 Upper operation limit value decision unit
503 Rotation speed command value decision unit
504 Command value setting unit
505 Upper limit determination unit
506 Compressor rotation control unit
Irmt Upper current limit value
Rc Rotation speed command value
Rnow Present rotation speed
Rrmax Upper operation limit value
Tr Actual discharge temperature
Ttgt Target discharge temperature
ΔTt Target discharge temperature difference

1. An air-conditioning apparatus comprising a housing configured to accommodate a refrigerant circuit including: a compressor; a condenser; a decompression device; and an evaporator, and a control device, wherein the control device includes:
an upper operation limit value decision unit;
a rotation speed command value decision unit; and
a compressor rotation control unit,
the upper operation limit value decision unit executes control of deciding an upper operation limit value that is an upper rotation speed limit for driving the compressor, with reference to a load on the compressor,
the rotation speed command value decision unit is capable of executing control of:
deciding a rotation speed command value with reference to a target discharge temperature and a rotation speed of the compressor in a present state (hereinafter referred to as the “present rotation speed”.) in a case where the load is relatively low; and deciding that the present rotation speed or the upper operation limit value is the rotation speed command value in a case where the load is relatively high, and
the compressor rotation control unit controls the drive of the compressor on the basis of the rotation speed command value.

2. The air-conditioning apparatus according to claim 1, wherein
the upper operation limit value decision unit
determines that a state of the compressor is any of a state in which the load is relatively low (hereinafter referred to as the “low-load condition.”), a first state in which the load is relatively high (hereinafter referred to as the “first high-load condition.”), or a second state in which the load is relatively high and current consumed is required to be reduced (hereinafter referred to as the “second high-load condition.”), and decides the upper operation limit value with reference to the determined state.

3. The air-conditioning apparatus according to claim 2, wherein the upper operation limit value decision unit
sets a maximum rotation speed of the compressor as the upper operation limit value in a case of the low-load condition,
sets the present rotation speed as the upper operation limit value in a case of the first high-load condition, and
sets a rotation speed reduced from the present rotation speed as the upper operation limit value in a case of the second high-load condition.

4. The air-conditioning apparatus according to claim 2, wherein the rotation speed command value decision unit sets, as the rotation speed command value, a value obtained by increasing or decreasing, or maintaining the present rotation speed with reference to a difference between the target discharge temperature and an actual discharge temperature in a case of the low-load condition.

5. The air-conditioning apparatus according to claim 2, wherein, in a case of the first high-load condition, the rotation speed command value decision unit reduces the present rotation speed upon judging that an actual discharge temperature is a low temperature, and sets the present rotation speed as the rotation speed command value upon judging that the actual discharge temperature is not a low temperature.

6. The air-conditioning apparatus according to claim 2, wherein the rotation speed command value decision unit decides that the upper operation limit value is the rotation speed command value in a case of the second high-load condition.

7. The air-conditioning apparatus according to claim 4, wherein the rotation speed command value decision unit decides the rotation speed command value with the upper operation limit value as an upper limit.

8. The air-conditioning apparatus according to claim 2, wherein the control device stops the compressor upon the upper operation limit value decided in a case of the second high-load condition falling below a minimum rotation speed of the compressor-of.

9. The air-conditioning apparatus according to claim 2, wherein the rotation speed command value decision unit decides that a minimum rotation speed of the compressor is the rotation speed command value upon the rotation speed command value set in a case of the first high-load condition or the low-load condition falling below the minimum rotation speed.

10. The air-conditioning apparatus according to claim 1, wherein the air-conditioning apparatus is configured in such a manner that the condenser is placed below the evaporator, and condensed water produced by the evaporator is caused to flow down to the condenser.

11. The air-conditioning apparatus according to claim 5, wherein the rotation speed command value decision unit decides the rotation speed command value with the upper operation limit value as an upper limit.
